(19) United States
(12) Patent Application Publication
(10) Pub. No.: US 2026/0292852 A1
(43) Pub. Date: Sep. 24, 2026

(54) SIDELINK POSITIONING REFERENCE SIGNAL RESOURCE RESERVATION INDICATION

(71) Applicant: QUALCOMM Incorporated, San Diego, CA (US)

(72) Inventors: Alexandros MANOLAKOS, Athens (GR); Gabi SARKIS, San Diego, CA (US)

(21) Appl. No.: 19/472,141

(22) PCT Filed: Apr. 26, 2024
(86) PCT No.: PCT/US2024/026512

§ 371 Date: Oct. 3, 2025

(30) Foreign Application Priority Data
Jun. 2, 2023 (GR) 20230100443

(51) Int. Cl. H04W 72/25; H04W 64/00; H04W 72/0446

(52) U.S. Cl. CPC H04W 72/25; H04W 64/006; H04W 72/0446

(57) ABSTRACT

A method of reserving a sidelink positioning reference signal resource includes transmitting, from a user equipment, a wireless sidelink message including a first slot of information comprising control information that indicates a second slot, to be transmitted after the first slot, and that includes a reservation indication of a particular sidelink positioning reference signal (SL PRS resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.

### CROSS-REFERENCE TO RELATED APPLICATIONS

This application claims the benefit of Greek Patent Application No. 20230100443, filed Jun. 2, 2023, entitled “SIDELINK POSITIONING REFERENCE SIGNAL RESOURCE RESERVATION INDICATION,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example user equipment includes: one or more memories; one or more transmitters; and one or more processors, communicatively coupled to the one or more memories and the one or more transmitters, configured to transmit, via the one or more transmitters, a wireless sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.

An example method of reserving a sidelink positioning reference signal resource includes transmitting, from a user equipment, a wireless sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.

Another example user equipment includes: means for determining a sidelink message; and means for transmitting the sidelink message wirelessly, the sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.

An example non-transitory, processor-readable storage medium includes processor-readable instructions to cause one or more processors of a user equipment to transmit a sidelink message wirelessly via one or more transmitters of the user equipment, the sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5 is a simplified block diagram of an example user equipment.

FIG. 6 is a simplified block diagram of an example network entity.

FIG. 7 is a simplified diagram of an example scenario of interest for sidelink-only positioning and/or joint Uu and sidelink positioning.

FIG. 8 is a simplified diagram of another example scenario of interest for sidelink-only positioning and/or joint Uu and sidelink positioning.

FIG. 9 is a block diagram of a frame structure for signal transmission.

FIG. 10 is a block diagram of a resource pool for positioning within a sidelink resource pool for communication.

FIG. 11A is a block diagram of an example arrangement of a resource pool for sidelink communications and a resource pool for sidelink positioning.

FIG. 11B is a block diagram of another example arrangement of a resource pool for sidelink communications and a resource pool for sidelink positioning.

FIG. 11C is a block diagram of another example arrangement of a resource pool for sidelink communications and a resource pool for sidelink positioning.

FIG. 12A is a block diagram of an arrangement of sidelink positioning control information and corresponding sidelink positioning reference signal transmission within a single slot.

FIG. 12B is a block diagram of another arrangement of sidelink positioning control information in one slot and corresponding sidelink positioning reference signal transmission in another slot.

FIG. 13 is a block diagram of control information in a current slot with an explicit indication of a reserved positioning reference signal resource in a future slot.

FIG. 14 is a block diagram of control information in a current slot with a combined implicit and explicit indication of a reserved positioning reference signal resource in a future slot.

FIG. 15 is a simplified diagram of an example of control information in a slot with an explicit indication of a positioning reference signal resource in the slot, an explicit indication of a future slot, and an explicit indication of a reserved positioning reference signal resource for the future slot.

FIG. 16 is a simplified diagram of an example of control information in a slot with a combined implicit and explicit indication of a positioning reference signal resource in the slot, an explicit indication of multiple future slots, and a combined implicit and explicit indication of a reserved positioning reference signal resource for the future slots.

FIG. 17 is a simplified diagram of an example of control information in a slot with a combined implicit and explicit indication of a positioning reference signal resource in the slot, an explicit indication of multiple futures slot, and an implicit indication of a reserved positioning reference signal resource for the future slots.

FIG. 18 is a process and signal flow for transmitting sidelink messages including control information in a slot of a sidelink message reserving a PRS resource in a future slot of another sidelink message.

FIG. 19 is a block flow diagram of a method of reserving a sidelink positioning reference signal resource.

### DETAILED DESCRIPTION

Techniques are discussed herein for reserving positioning reference signals for sidelink signal transfer. For example, control information in a sidelink slot may indicate a sidelink position reference signal (SL-PRS) resource to be reserved in one or more future slots, indicating that that SL-PRS will be used for SL-PRS transfer. A particular SL-PRS may be specified, for example, explicitly through a bit string uniquely identifying which SL-PRS resource from a set of available SL-PRS resources to reserve. As another example, a particular SL-PRS may be specified by implicitly indicating a subset of the set of available SL-PRS resources and explicitly indicating one of the SL-PRS resources within the implicitly-indicated subset of available SL-PRS resources.

The subset of available SL-PRS resources may be indicated by a “location” (e.g., a combination of symbol and subcarrier(s) within a slot) of the explicit indication of the SL-PRS resource within the subset. Other configurations, however, may be used.

Items and/or techniques described herein may provide one or more of the following capabilities, as well as other capabilities not mentioned. Sidelink PRS resources to be reserved in a future slot may be uniquely identified in a current slot.

Sidelink control information overhead may be conserved in order to uniquely identify a PRS resource to be reserved in a future slot and/or to be used in a present slot, e.g., by implicitly indicating a subset of SL-PRS resources and explicitly indicating one of the SL-PRS resources within the subset of SL-PRS resources. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IOT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. A V-UE (Vehicle UE) is a type of UE and may be any in-vehicle wireless communication device, such as a navigation system, a warning system, a head-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE (Pedestrian UE) is a type of UE and may be a portable wireless communication device that is carried by a pedestrian (i.e., a user that is not driving or riding in a vehicle).

Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IOT), enhanced mobile broadband (eMBB), or others) that may provide access for different types of devices. In some examples, the term “cell” may refer to a portion of a geographic coverage area (for example, a sector) over which the logical entity operates.

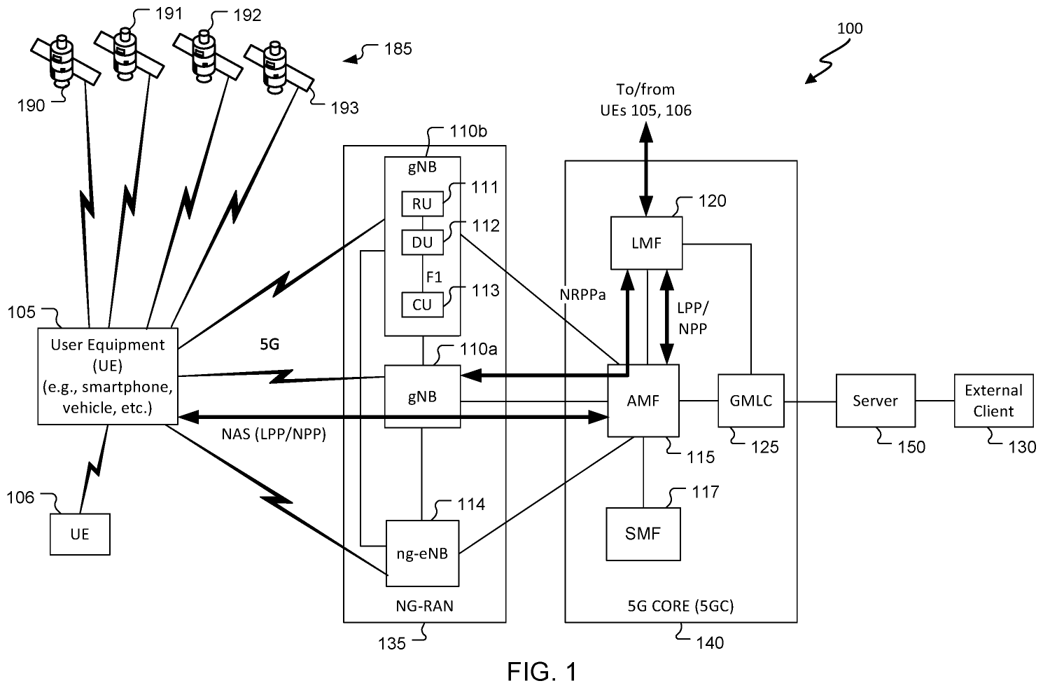

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP.

The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi®, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name.

Moreover, the UE 105 may correspond to a cellphone, smartphone, laptop, tablet, PDA, consumer asset tracking device, navigation device, Internet of Things (IOT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level).

Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®), and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1: M) system in which each UE may transmit to other UEs in the group. A TRP may facilitate scheduling of resources for D2D communications. In other cases, D2D communications may be carried out between UEs without the involvement of a TRP.

One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUS, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b.

The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node / system that implements the LMF 120 may additionally or alternatively implement other types of location-support modules, such as an Enhanced Serving Mobile Location Center (E-SMLC) or a Secure User Plane Location (SUPL) Location Platform (SLP).

At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QOS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

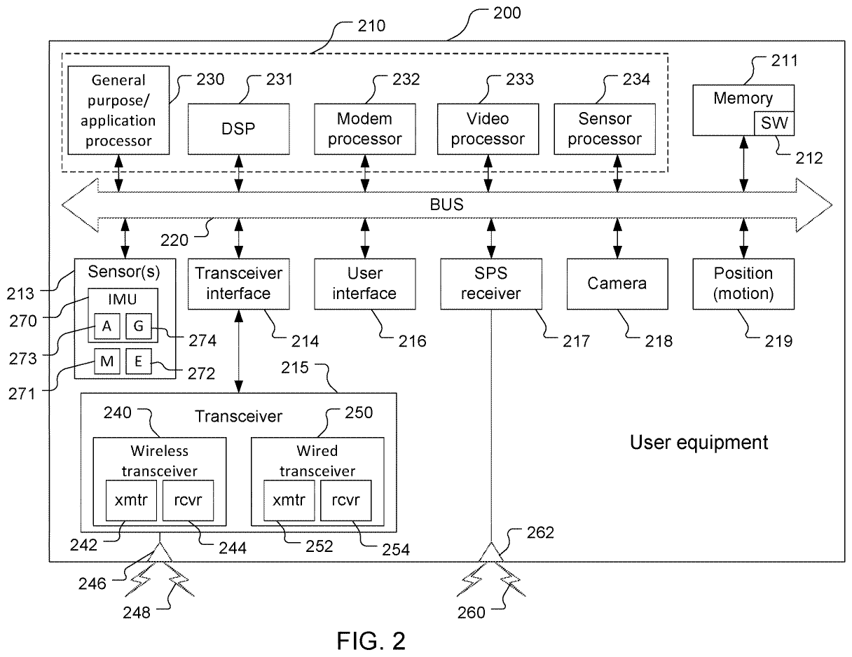

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc.

The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs).

For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication.

The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

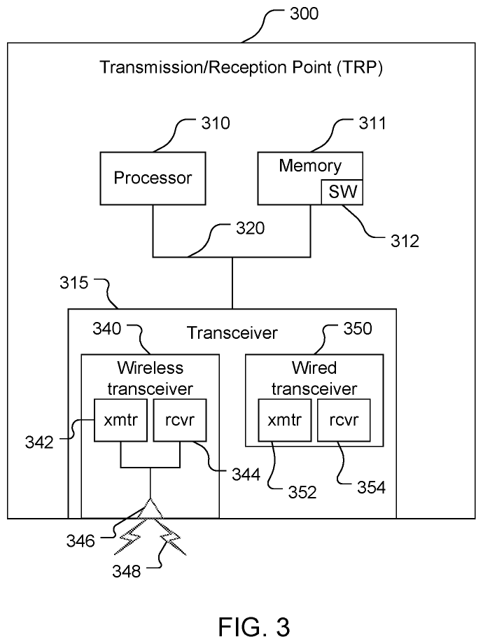

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2).

The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used.

For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

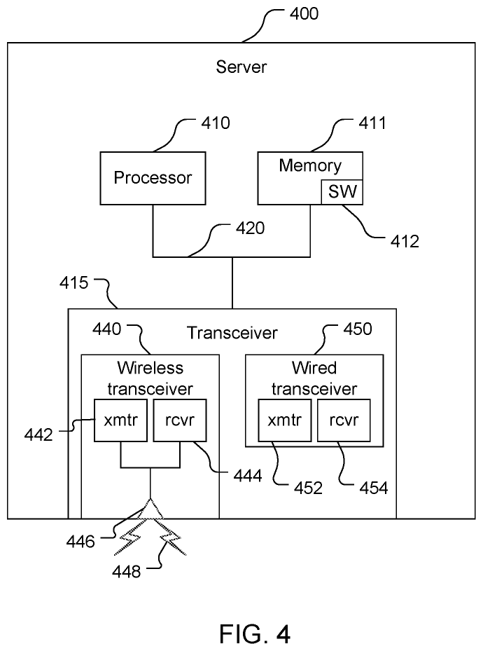

Referring also to FIG. 4, a server 400, of which the LMF 120 may be an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V 2X (PC5), IEEE 802.11 (including IEEE 802.11p), WiFi®), WiFi® Direct (WiFi®-D), Bluetooth®, Zigbee® etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS), uplink PRS (UL PRS) (which may be called SRS (Sounding Reference Signal) for positioning), and sidelink PRS (SL PRS). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nth resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot.

PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

### PRS Resource Reservation

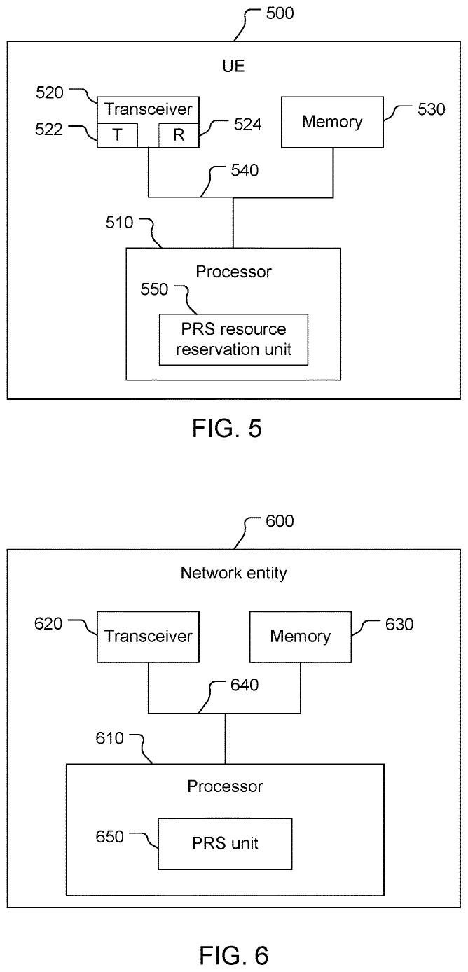

Referring also to FIG. 5, a UE 500 includes a processor 510, a transceiver 520, and a memory 530 communicatively coupled to each other by a bus 540. Even if referred to in the singular, the processor 510 may include one or more processors, the transceiver 520 may include one or more transceivers (e.g., one or more transmitters 522 and/or one or more receivers 524), and the memory 530 may include one or more memories. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function.

The processor 510 (possibly in conjunction with the memory 530 and, as appropriate, the transceiver 520) may include a PRS resource reservation unit 550. The PRS resource reservation unit 550 may be configured to reserve a PRS resource (e.g., an SL-PRS resource) in a future slot by providing control information in a current (present) slot of a sidelink message. The PRS resource reservation unit 550 is discussed further below, and the description may refer to the processor 510 generally, or the UE 500 generally, as performing any of the functions of the PRS resource reservation unit 550, with the UE 500 being configured to perform the function(s).

Referring also to FIG. 6, a network entity 600 includes a processor 610, a transceiver 620, and a memory 630 communicatively coupled to each other by a bus 640. Even if referred to in the singular, the network entity 600 may include one or more network entities, the processor 610 may include one or more processors, the transceiver 620 may include one or more transceivers (e.g., one or more transmitters and/or one or more receivers), and the memory 630 may include one or more memories. The network entity 600 may include the components shown in FIG. 6 and may be configured to be a component of a communication network (e.g., a terrestrial communication network such as a cellular network). The network entity 600 may include one or more other components such as any of those shown in FIG. 4 such that the server 400 may be an example of the network entity 600. For example, the processor 610 may include one or more of the components of the processor 410. The transceiver 620 may include one or more of the components of the transceiver 415. The memory 630 may be configured similarly to the memory 411, e.g., including software with processor-readable instructions configured to cause the processor 610 to perform functions. Also or alternatively, the network entity 600 may include one or more other components such as any of those shown in FIG. 3 such that the TRP 300 may be an example of the network entity 600. For example, the processor 610 may include one or more of the components of the processor 310. The transceiver 620 may include one or more of the components of the transceiver 315. The memory 630 may be configured similarly to the memory 311, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) may include a PRS unit 650. The PRS unit 650 is configured to allocate PRS resources, and the description may refer to the processor 610 generally, or the network entity 600 generally, as performing any of the functions of the PRS unit 650, with the network entity 600 being configured to perform the function(s).

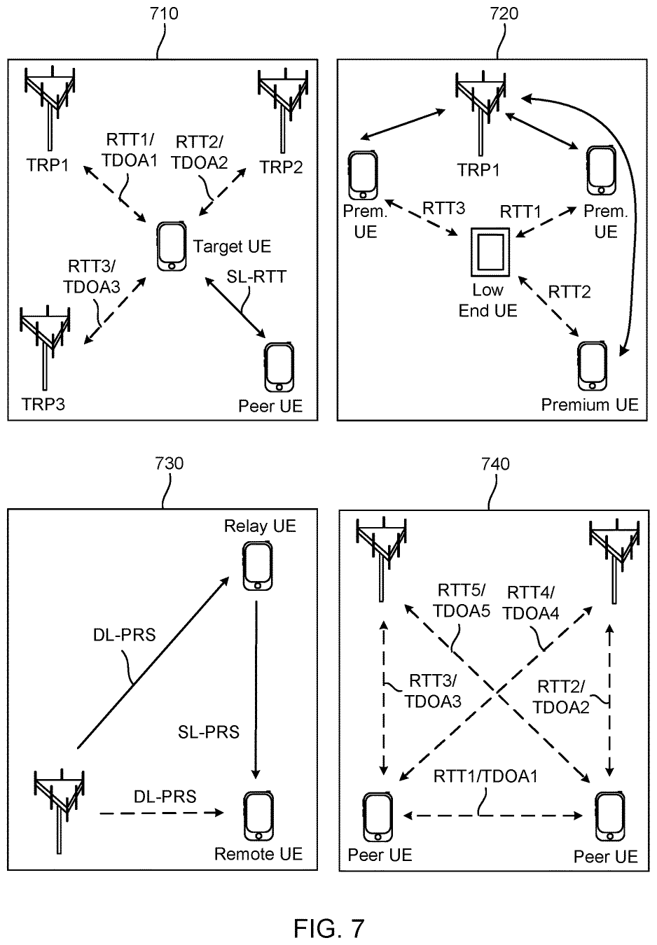

Referring to FIG. 7, NR supports, or enables, various sidelink positioning techniques, including various scenarios for sidelink-only or joint Uu and sidelink positioning. In a scenario 710, at least one peer UE with a known location may improve the Uu-based positioning (e.g., multi-cell round-trip-time (RTT), downlink time difference of arrival (DL-TDOA), etc.) of a target UE by providing an additional anchor (e.g., using sidelink RTT (SL-RTT)). In a scenario 720, a low-end (e.g., reduced capacity, or “RedCap”) target UE may obtain the assistance of premium UEs to determine its location using, e.g., sidelink positioning and ranging procedures with the premium UEs. Compared to the low-end UE, the premium UEs may have more capabilities, such as more sensors, a faster processor, more memory, more antenna elements, higher transmit power capability, access to additional frequency bands, or any combination thereof. In a scenario 730, a relay UE (e.g., with a known location) may participate in the positioning estimation of a remote UE without performing uplink positioning reference signal (PRS) transmission over the Uu interface. In a scenario 740, joint positioning of multiple UEs may be performed. In this example, two UEs with unknown positions may be jointly located in non-line-of-sight (NLOS) conditions by utilizing constraints from nearby UEs.

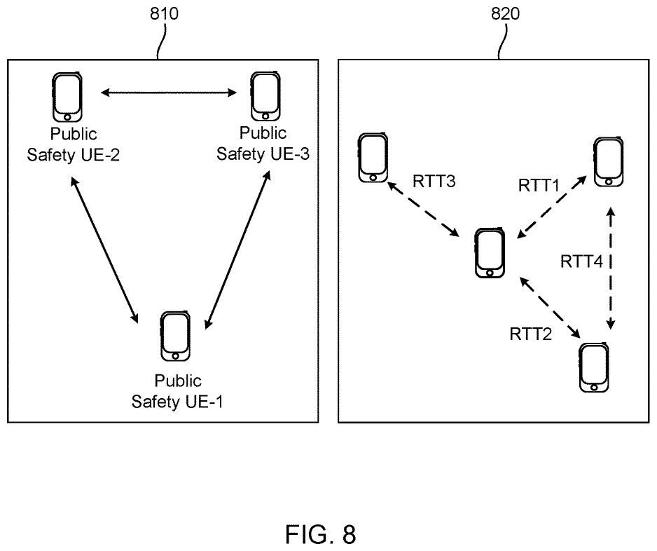

Referring also to FIG. 8, still other scenarios may be used for sidelink-only or joint Uu and sidelink positioning. In a scenario 810, UEs used for public safety (e.g., by police, firefighters, and/or the like) may perform peer-to-peer (P2P) positioning and ranging for public safety and other uses. For example, the public safety UEs may be out of coverage of a network and determine a location or a relative distance and a relative position among the public safety UEs using sidelink positioning techniques. Similarly, in a scenario 820, multiple UEs that are out of coverage may determine a location or a relative distance and a relative position using sidelink positioning techniques, such as SL-RTT.

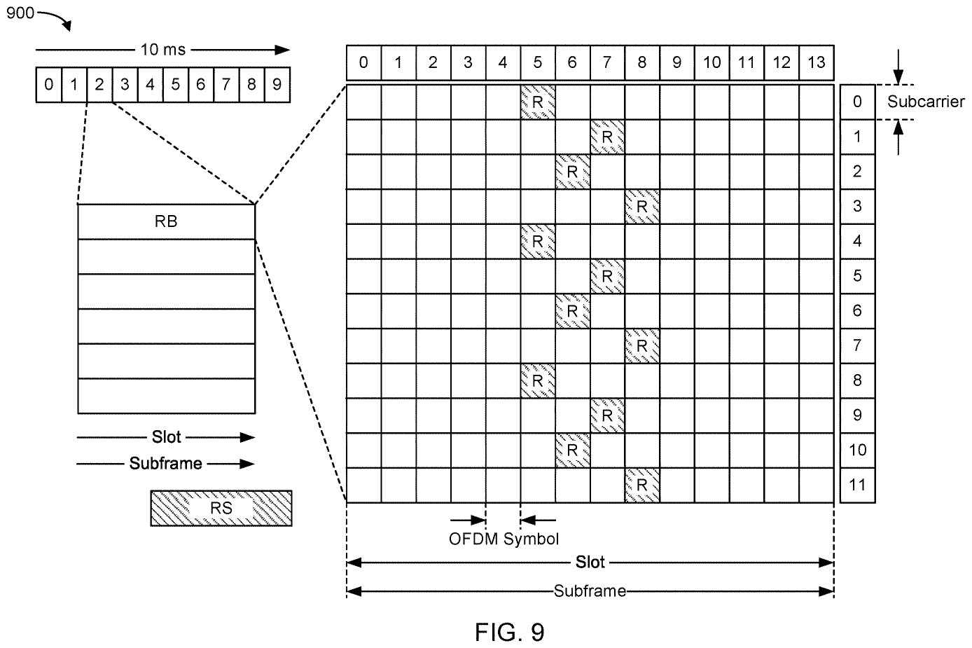

Referring to FIG. 9, a frame structure 900 is an example of one of various possible frame structures that may be used to support downlink and uplink transmissions between network nodes (e.g., base stations and UEs). The frame structure 900 may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 9, a numerology of 15 kHz is used. Thus, in the time domain, a 10 ms frame is divided into 10 equally sized subframes of 1 ms each, and each subframe includes one time slot. In FIG. 9, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 9, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 9 illustrates example locations of REs carrying a reference signal (labeled “R”).

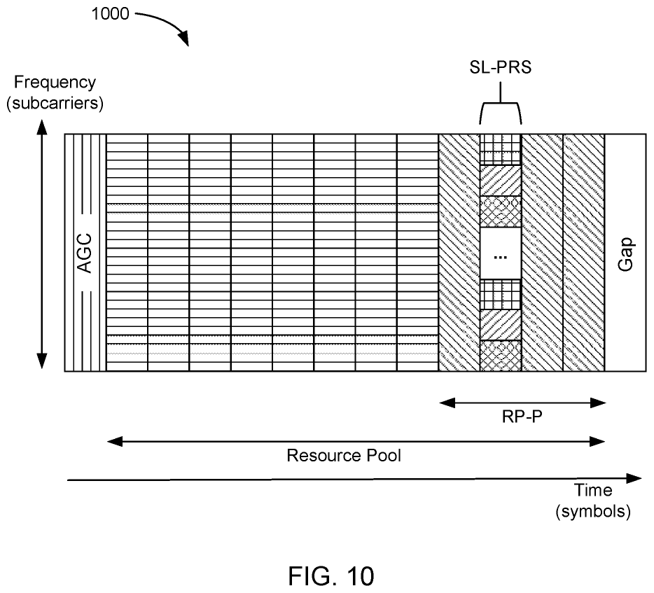

Referring also to FIG. 10, an example of a resource pool 1000 for positioning is configured within a sidelink resource pool for communication (i.e., a shared resource pool). In the time domain, the length of each block is an orthogonal frequency division multiplexing (OFDM) symbol, and the 14 symbols make up a slot. In the frequency domain, the height of each block is a subcarrier (or subchannel).

In the resource pool 1000, the entire slot (except for the first and last symbols) may be a resource pool for sidelink communication. That is, any of the symbols other than the first and last symbols may be allocated for sidelink communication. An RP-P may be allocated in the last four pre-gap symbols of the slot. As such, non-sidelink positioning data, such as user data (PSSCH), CSI-RS, and control information, may only be transmitted in the first eight post-AGC symbols and not in the last four pre-gap symbols to prevent a collision with the configured RP-P. The non-sidelink positioning data that would otherwise be transmitted in the last four pre-gap symbols may be punctured or muted, or the non-sidelink data that would normally span more than the eight post-AGC symbols may be rate matched to fit into the eight post-AGC symbols.

Sidelink PRS (SL-PRS) have been defined to enable sidelink positioning procedures among UEs. Like a downlink PRS (DL-PRS), an SL-PRS resource is composed of one or more resource elements (i.e., one OFDM symbol in the time domain and one subcarrier in the frequency domain). SL-PRS resources have been designed with a comb-based pattern to enable fast Fourier transform (FFT)-based processing at the receiver. SL-PRS resources are composed of unstaggered, or only partially staggered, resource elements in the frequency domain to provide small time of arrival (TOA) uncertainty and reduced overhead of each SL-PRS resource. SL-PRS may also be associated with specific RP-Ps (e.g., certain SL-PRS may be allocated in certain RP-Ps). SL-PRS have also been defined with intra-slot repetition (not shown in FIG. 10) to allow for combining gains (as appropriate). There may also be inter-UE coordination of RP-Ps to provide for dynamic SL-PRS and data multiplexing while attempting to avoid SL-PRS collisions.

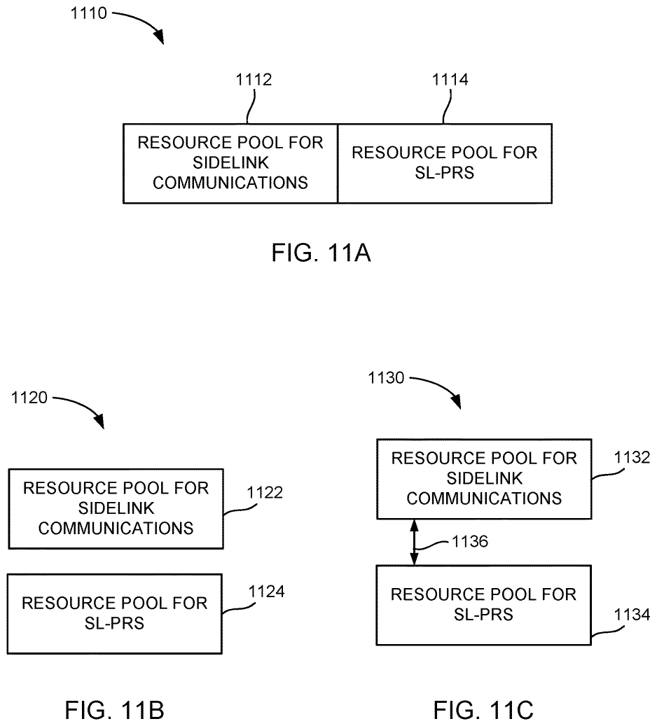

Referring also to FIGS. 11A, 11B, and 11C, separate resource pools may be configured for sidelink communications and SL-PRS, respectively. SL-PRS may be transmitted in a dedicated resource pool that is dedicated to PRS and thus includes PRS and control information, but not data (e.g., communication data). SL-PRS may be transmitted in a shared resource pool that includes PRS and data.

Referring to FIGS. 11A-11C, various examples of arranging a resource pool for sidelink communications and a resource pool for SL-PRS are provided. In the examples shown in FIGS. 11A-11C, time is represented horizontally and frequency is represented vertically.

In a first arrangement 1110, a resource pool 1112 for sidelink communications and a resource pool 1114 for SL-PRS may be time-division multiplexed within a time segment and thus correspond to different sets of slots in the time domain. The resource pool 1112 for sidelink communications and the resource pool 1114 for SL-PRS may correspond to the same set of sub-channels.

In a second arrangement 1120, a resource pool 1122 for sidelink communications and a resource pool 1124 for SL-PRS may be frequency-division multiplexed within a frequency segment and thus correspond to different sets of sub-channels in the frequency domain. The resource pool 1122 for sidelink communications and the resource pool 1124 for SL-PRS may correspond to the same set of slots.

In a third arrangement 1130, a resource pool 1132 for sidelink communications and a resource pool 1134 for SL-PRS may correspond to different sets of sub-channels in the frequency domain that have a frequency gap 1136 therebetween in the frequency domain. The resource pool 1132 for sidelink communications and the resource pool 1134 for SL-PRS may still correspond to the same set of slots. The resource pool 1132 for sidelink communications and the resource pool 1134 for SL-PRS may correspond to different sets of slots.

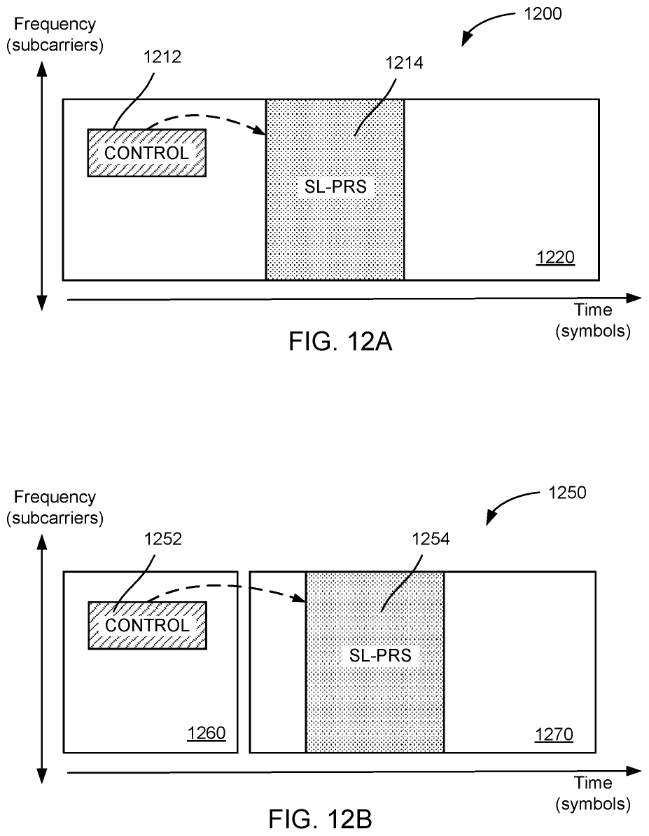

Referring to FIGS. 12A and 12B, various resource arrangements may be used for providing sidelink positioning control information and one or more corresponding SL-PRS transmissions. Sidelink positioning control information may be transmitted in order to provide information regarding one or more SL-PRS transmissions. The sidelink positioning control information may indicate, for the one or more SL-PRS transmissions, location, triggering, reservation, and/or activation of resources, parameters, or any combination thereof, for the one or more SL-PRS transmissions.

The sidelink positioning control information may be included in a single-stage sidelink control information (SCI-1) message, a two-stage sidelink control information (SCI-2) message, a downlink control information (DCI) message, a medium access control layer control element (MAC-CE) message, a PC5 radio resource control (PC5-RRC) message, a higher-layer message (e.g., an application layer message), or any combination thereof. The discussion herein focuses on the use of SCI-1 messages. The higher-layer message may correspond to a message at a protocol layer above a physical layer in a protocol stack.

Control information and SL-PRS may be transmitted with various relationships. For example, the sidelink positioning control information and the corresponding one or more SL-PRS transmissions may use resources on the same carrier or on different carriers. As another example, the sidelink positioning control information and the corresponding one or more SL-PRS transmissions may use resources in the same resource pool or in different resource pools.

In a first example arrangement 1210, sidelink positioning control information and one or more corresponding SL-PRS transmissions may use resources in the same resource pool 1220. For example, the sidelink positioning control information may use control information 1212 (labeled as “CONTROL”) in a PSCCH in the resource pool 1220 in order to provide information regarding one or more SL-PRS transmissions (as represented by the dashed arrow). Also, the one or more corresponding SL-PRS transmissions may use an SL-PRS resource 1214 (labeled as “SL-PRS”) in the same resource pool 1220.

In a second example arrangement 1250, the sidelink positioning control information and the corresponding one or more SL-PRS transmissions may use resources in two different resource pools 1260 and 1270. For example, the sidelink positioning control information may use control information 1252 (labeled as “CONTROL”) in the resource pool 1260 in order to provide information regarding one or more SL-PRS transmissions (as represented by the dashed arrow). Also, the one or more corresponding SL-PRS transmissions may use an SL-PRS resource 1254 (labeled as “SL-PRS”) in another resource pool, here the resource pool 1270.

In the arrangement 1250, the control information 1252 reserves future resources for PRS. The control information 1252 indicates one or more resources that are scheduled for one or more future slots (e.g., a slot of the resource pool 1270) that will be transmitted after a slot (of the resource pool 1260) in which the control information 1252 is transmitted. The control information may thus perform reservation of one or more future resources for future PRS transmission. While the control information 1252 of a first slot may reserve one or more resources in a second (future) slot, the second slot will also have control information indicating the PRS for transmission in the second slot. The reservation of the resource(s) in the second slot by the control information in the first slot, however, may provide sufficient advance warning to enable devices to plan (e.g., adjust) signal transmissions to help avoid signal collisions in the second slot by avoiding transmitting signals in reserved resources, or even avoiding requesting transmission in reserved resources.

Various configurations of control information may be used in a sidelink slot of a sidelink message to reserve a PRS resource in a future sidelink slot. Control information may take any of a variety of forms for uniquely identifying (explicitly, implicitly, or a combination thereof) in one sidelink slot (e.g., a first slot) which PRS resource is reserved in a future sidelink slot (e.g., a second slot to be transmitted after the first slot).

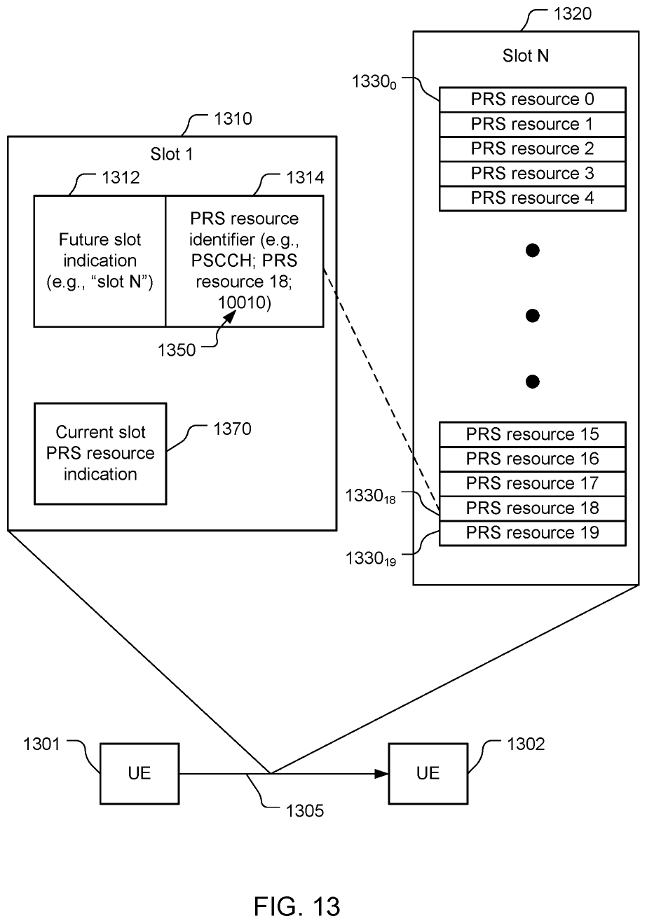

Referring also to FIG. 13, as an example of control information being used in a sidelink slot of a sidelink message to reserve a PRS resource in a future sidelink slot, a UE 1301 (which is an example of the UE 500) may transmit sidelink messages 1305 to a UE 1302. The sidelink messages 1305 may include a current sidelink slot 1310 that may include an explicit indication of which PRS resource of a future sidelink slot 1320 (later transmitted by the UE 1301) is reserved. A future slot indication 1312 may include an explicit indication, e.g., a binary number, corresponding to the future sidelink slot 1320, e.g., a binary number of a quantity of slots after the current sidelink slot 1310. The future slot indication 1312 may be separate from, and applicable to, any indication of a reserved PRS resource in a PRS resource identifier 1314, or may be part of the PRS resource identifier (e.g., part of a PSCCH message). The PRS resource identifier 1314 may comprise a bit string 1350 to uniquely identify a reserved PRS resource from among available PRS resources 1330₀-1330₁₉ in a PRS resource set 1340. A quantity of bits in the bit string 1350 may be equal to log₂(a quantity of the available PRS resources in the future slot) rounded to a next highest integer. In this example, there are 20 (twenty) available PRS resources 1330₀-1330₁₉ in the future sidelink slot 1320 and thus the bit string 1350 has five (5) bits because log₂(20) is 4.32, and thus rounding to the next highest integer yields 5. Further in this example, a value of 10010 of the bit string 1350 indicates that an available PRS resource 1330₁₈ is reserved in the future sidelink slot 1320 (as indicated by the future slot indication 1312).

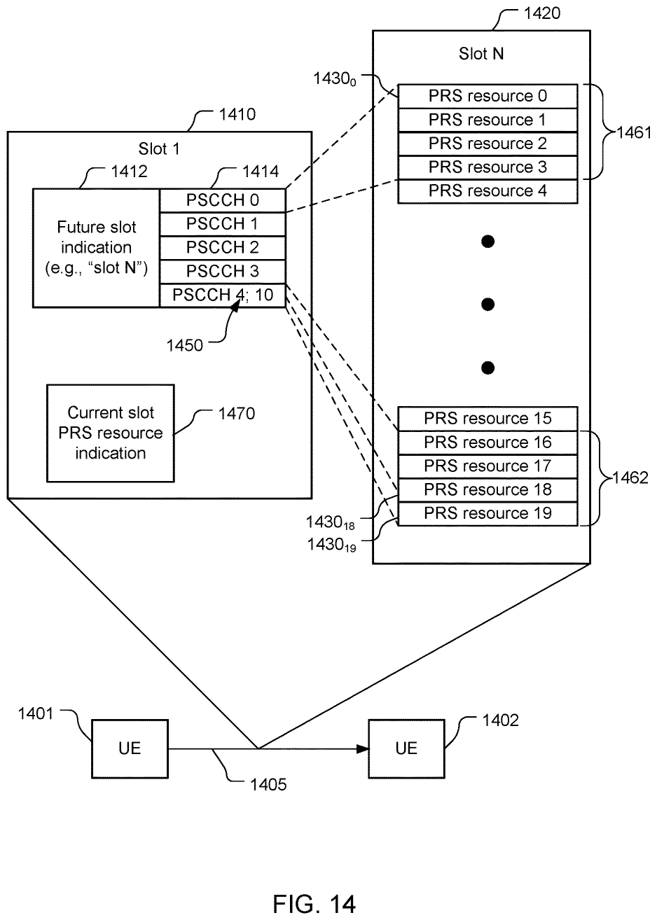

Referring also to FIG. 14, as another example of control information being used in a sidelink slot of a sidelink message to reserve a PRS resource in a future sidelink slot, a UE 1401 (which is an example of the UE 500) may transmit sidelink messages 1405 to a UE 1402. In the sidelink messages 1405 there may be a mapping between control information (e.g., a PSCCH resource) and one or more SL-PRS resources. For example, each of one or more portions of the control information may be implicitly (e.g., by agreement) mapped to a subset of one or more respective available SL-PRS resources in a future slot relative to the slot containing the control information. The control information may contain an explicit indication that uniquely identifies one of the SL-PRS resources within the subset of available SL-PRS resources. This may reduce a quantity of bits used in the control information to reserve a PRS resource in a future slot, relative to a bit string that can identify any of a total quantity of available PRS resources, and thus reduce/limit control overhead to reserve a PRS resource.

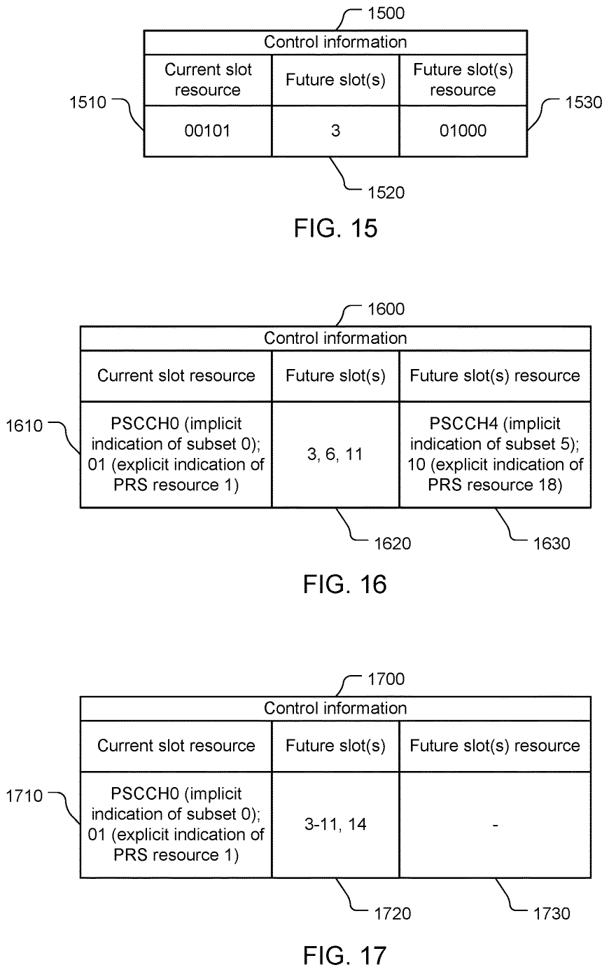

As shown in FIG. 14, a current sidelink slot 1410 may include an explicit indication of in which future slot a PRS resource is reserved. A future slot indication 1412 may include an explicit indication, e.g., a binary number (e.g., as shown in a future slot(s) indication 1520 in FIG. 15), corresponding to the future sidelink slot 1420, e.g., a binary number of a quantity of slots after the current sidelink slot 1410. The future slot indication 1412 may be separate from, and applicable to, any indication of a reserved PRS resource in a PRS resource identifier 1414, or may be part of the PRS resource identifier 1414 (e.g., part of a PSCCH message).

As shown in FIG. 14, a current sidelink slot 1410 may include a combined implicit and explicit indication of which PRS resource of the future sidelink slot 1420 is reserved. The PRS resource identifier 1414 may include an implicit indication of a subset of available PRS resources and an explicit indication of one of the available PRS resources in the implicitly-indicated subset of PRS resources.

A “location” of control information may implicitly indicate a subset of available PRS resources. For example, the PRS resource identifier 1414 may comprise a set of available control information resources, e.g., here available control information channels, specifically available PSCCH channels 1416₀-1416₄. In this example, there are five (5) available PSCCH channels 1416₀-1416₄, but there may be a different quantity of available control information resources, e.g., PSCCH channels. Also in this example, there are 20 (twenty) available PRS resources 1430₀-1430₁₉ in the future sidelink slot 1420. Consequently, each of the available PSCCH channels 1416₀-1416₄ implicitly correspond to four (4) of the available PRS resources 1430₀-1430₁₉. There may be a different quantity of available PRS resources, and different subsets of available PRS resources may contain different quantities of available PRS resources (e.g., if there were 19 available PRS resources and 5 available PSCCH channels, then there could be four subsets of four available PRS resources and one subset of three available PRS resources). The “location” of each of the PSCCH channels 1416₀-1416₄, i.e., one or more respective subcarriers or a respective combination of one or more symbols and one or more subcarriers, implicitly corresponds to a respective subset off the available PRS resources 1430₀-1430₁₉. For example, the location of the PSCCH channel 1416₀ corresponds to a first subset of the PRS resources, here a subset 1461, and the location of the PSCCH channel 1416₀ corresponds to a second subset of the PRS resources, here a subset 1462.

Combined with the implicit indication of the subset of PRS resources corresponding to the PSCCH location, control information (here a PSCCH) for the subset in which the desired PRS resource resides includes an explicit indication of the desired PRS resource within the corresponding subset of PRS resources. For example, a bit string 1450 uniquely identifies a reserved PRS resource from among available PRS resources in the PRS resource subset 1462. In this example, the bit string 1450 is “10” indicating the third PRS source within the PRS resource subset 1462, i.e., a PRS resource 1430₁₈. A quantity of bits in the bit string 1450 may be equal to log₂(a quantity of the available PRS resources in the PRS resource subset) rounded to a next highest integer. In this example, there are 4 (four) available PRS resources in each PRS resource subset and thus the bit string 1450 has two (2) bits because log₂(4) is two (2). Thus, in this example, a value of “10” of the bit string 1450 indicates that an available PRS resource 1430₁₈ is reserved in the future sidelink slot 1420, using two bits to reserve the available PRS resource 1430₁₈ instead of the five bits used in the example shown in FIG. 13 to reserve the available PRS resource 1330₁₈.

The control information may indicate a PRS resource to be used in the current slot. For example, the control information in the current sidelink slot 1310 may include a current slot PRS resource indication 1370 and/or the control information in the current sidelink slot 1410 may include a current slot PRS resource indication 1470. For example, one or both of the current slot PRS resource indications 1370, 1470 may comprise an explicit indication uniquely identifying one of the available PRS resources 1330₀-1330₁₉, 1430₀-1430₁₉, similar to the PRS resource identifier 1314. For example, referring also to FIG. 15, control information 1500 in a slot of a sidelink message may include an explicit indication 1510 of a PRS resource in the current slot (i.e., the slot containing the control information 1500). In this example, the explicit indication 1510 has a value of “00101” indicating the PRS resource 4. A future slot(s) resource indication 1530 may be an explicit indication (as in this example), an implicit indication (e.g., as discussed with respect to FIG. 17), or a combined implicit and explicit indication (e.g., as discussed with respect to FIG. 16). As another example, one or both of the current slot PRS resource indications 1370, 1470 may comprise an implicit PRS resource subset indication and an explicit indication uniquely identifying one of the available PRS resources within an implicitly-indicated PRS resource subset, similar to the PRS resource identifier 1414. For example, referring also to FIG. 16, control information 1600 in a slot of a sidelink message may include a PRS resource indication 1610 that includes both an implicit indication (here of a PRS resource subset based on a PSCCH location) and an explicit indication of a PRS resource in the PRS resource subset. In this example, the location of PSCCH0 is an implicit indication of PRS resource subset 0 and an explicit indication of “01” indicates the second PRS resource in the corresponding PRS resource subset, in this example PRS resource 1. Also in this example, a future slot(s) resource indication 1630 includes an implicit indication of a PRS resource subset and an explicit indication of a PRS resource within the implicitly-indicated PRS resource subset. In this example, future slot(s) resource indication 1630 includes the PSCCH4 implicitly indicating a fifth PRS resource subset and an explicit indication of “10” indicating a third PRS resource in the subset, and thus PRS resource 18 in the example of four PRS resources per PRS resource subset. The PRS resource indicated for the current slot may be the same as or different from (as shown in FIG. 16) the PRS resource for the future slot(s).

Multiple future slots may have the same PRS resource reserved. For example, the future slot indication 1312, 1412 may indicate multiple future slots and the PRS resource identifier 1314, 1414 may reserve the same PRS resource in each of the multiple identified future slots. The PRS resource indicated may be implicitly reserved for all indicated future slots, or an additional indication (e.g., a bit set to “1”) may be provided to explicitly indicate that the indicated PRS resource should be reserved for all indicated future slots. This may save overhead (e.g., by avoiding sending bits) in order to reserve the PRS resources, e.g., compared to sending the reservation in multiple slots. The indication of multiple future slots may take any of a variety of forms. For example, referring to FIG. 16, a future slot(s) indication 1620 of the control information 1600 provides explicit indications of multiple specific future slots, here slots 3, 6, and 11 after the current slot. As another example, referring to FIG. 17, a future slot(s) indication 1720 of control information 1700 provides an indication of a range of slots, here slots 3-11 after the current slot. In this example, a future slot(s) resource indication 1730 comprises an implicit indication (as discussed below) of a PRS resource. As another example, a future slot(s) indication of the control information may provide a combination of one or more specific slots and one or more ranges of slots, e.g., as shown in a future slot(s) indication 1720 that indicates both a range of slots (here, slots 3-11) and a specific slot outside of the range (here, the slot 14 after the current slot). Other forms of indications of multiple futures slots may be used.

The future slot(s) resource may be fully implicitly indicated. For example, referring to FIG. 17, if the PRS resource in the future slot(s) is the same as the PRS resource in the current slot, then a future slot(s) resource indication 1730 may not contain any explicit bits, with the PRS resource of the future slot(s) being implicitly the same as the indicated PRS resource of the current slot. As another example, if a PDCCH location (e.g., one or more subcarriers or a combination of one or more symbols and one or more subcarriers) corresponds to a subset of one PRS resource, then the presence of this PDCCH may implicitly (by the location of the PDCCH) indicate the reserved PRS resource. This may further conserve sidelink overhead by avoiding transmission of one or more bits to indicate the PRS resource of the future slot(s).

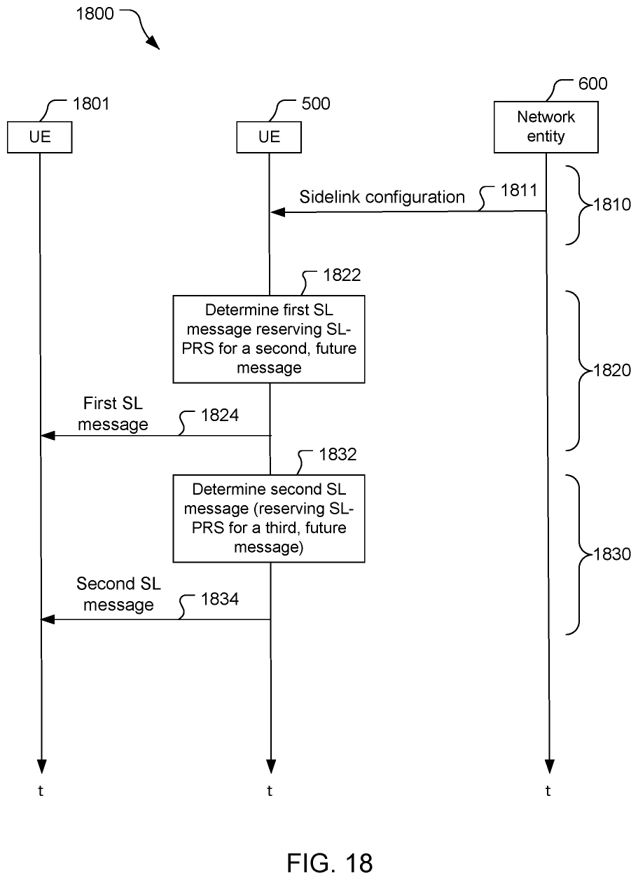

Referring to FIG. 18, with further reference to FIGS. 1-17, a signal and processing flow 1800 for reserving and transmitting SL-PRS from the UE 500 to a UE 1801 includes the stages shown. The flow 1800 is an example flow and not limiting.

The flow 1800 may be altered, e.g., by having one or more messages and/or one or more stages added, removed, rearranged, combined, performed concurrently, and/or having one or more messages and/or one or more stages split into multiple messages and/or stages.

At stage 1810, the network entity 600, e.g., the PRS unit 650, may determine and send a sidelink configuration message 1811 to the UE 500. The message 1811 may be sent using one or more higher layer messages (e.g., a MAC-layer message (e.g., a MAC-CE), an RLC-layer message, a PDCP-layer message, an SDAP-layer message, and/or a NAS-layer message. The message 1811 may instruct the UE 500 to implement explicit indication, implicit indication, or combined implicit and explicit indication, of a PRS resource for a current slot and/or to implement explicit indication, implicit indication, or combined implicit and explicit indication, of a PRS resource for one or more future slots (e.g., as discussed with respect to FIGS. 14-17).

At stage 1820, the UE 500, e.g., the PRS resource reservation unit 550, may determine and transmit a first SL message 1824 to the UE 1801. At sub-stage 1822, the UE 500 may determine the first SL message 1824 to reserve an SL-PRS for a second, future message. For example, a slot of the first SL message 1824 may explicitly, implicitly, or using an implicit/explicit combination, reserve an SL-PRS for each of one or more future slots, e.g., as discussed with respect to FIGS. 14-17. The UE 500 may transmit the first SL message 1824, as determined at stage 1822, to the UE 1801, with the first SL message 1824 including control information in one slot reserving a PRS resource for one or more future slots.

At stage 1830, the UE 500, e.g., the PRS resource reservation unit 550, may determine and transmit a second SL message 1834 to the UE 1801. At sub-stage 1832, the UE 500 may determine the second SL message 1834 to use the reserved SL-PRS indicated in the first SL message 1824 and may reserve an SL-PRS for a third, future message. For example, a slot of the second SL message 1834 may explicitly, implicitly, or using an implicit/explicit combination, reserve an SL-PRS for each of one or more future slots, e.g., as discussed with respect to FIGS. 14-17. The UE 500 may transmit the second SL message 1834, as determined at stage 1832, to the UE 1801, with the second SL message 1834 possibly including control information in one slot reserving a PRS resource for one or more future slots.

At any time, the UE 500 may receive a sidelink configuration message, such as the sidelink configuration message 1811, from the network entity 600 and may determine how to configure SL messages accordingly. For example, the UE 500 may respond to the sidelink configuration message by selecting (possibly changing) how to indicate SL PRS (of a present slot and/or reserved in one or more future slots), e.g., explicitly, implicitly, or using an implicit/explicit combination. As another example, the UE 500 may respond to the sidelink configuration message by determining whether an explicit indication (e.g., a bit string) is to be used to uniquely identify a PRS resource from an entire set of possible PRS resources or to uniquely identify a PRS resource from a subset of PRS resources of the entire set of possible PRS resources.

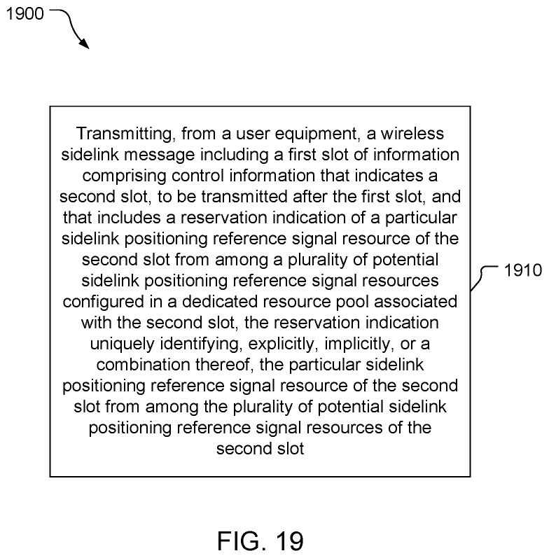

Referring to FIG. 19, with further reference to FIGS. 1-18, a method 1900 of reserving a sidelink positioning reference signal resource includes the stage shown. The method 1900 is, however, an example only and not limiting. The method 1900 may be altered, e.g., by having one or more stages added, and/or by having a single stage split into multiple stages.

At stage 1910, the method 1900 includes transmitting, from a user equipment, a wireless sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot. For example, the UE 1301, 1401 (e.g., the PRS resource reservation unit 550) may transmit a SL message including the slot 1310 with control information indicating a reserved PRS resource in a future slot, e.g., the slot 1320. The control information may explicitly indicated the reserved PRS resource, e.g., as shown in FIG. 15 and discussed above, implicitly indicated the reserved PRS resource, e.g., as shown in FIG. 17 and discussed above, or indicated the reserved PRS resource by a combination of an implicit indication and an explicit indication, e.g., as shown in FIGS. 14 and 16 and discussed above. The processor 510, possibly in combination with the memory 530, in combination with the transceiver 520 (e.g., the one or more transmitters 522), may comprise means for transmitting the wireless sidelink message.

Implementations of the method 1900 may include one or more of the following features. In an example implementation, transmitting the wireless sidelink message comprises transmitting the reservation indication, as one or more subcarriers or a combination of one or more symbols and one or more subcarriers, implicitly corresponding to a subset of the plurality of potential sidelink positioning reference signal resources configured in the dedicated SL PRS resource pool associated with the second slot, that contains less than all of the plurality of potential sidelink positioning reference signal resources configured in the dedicated SL PRS resource pool associated with the second slot, and wherein the reservation indication includes an explicit identifier that explicitly uniquely identifies the particular sidelink positioning reference signal resource of the second slot from among the subset of the plurality of potential sidelink positioning reference signal resources configured in the dedicated SL PRS resource pool associated with the second slot. For example, the location of a PSCCH, e.g., the PSCCH 4 of the PRS resource identifier 1414 may provide an implicit indication of a PRS resource subset and an explicit indication, e.g., the bit string 1450, may specify a member of the PRS resource subset as the PRS resource to reserve. In a further example implementation, the subset of the plurality of potential sidelink positioning reference signal resources of the second slot consists of a first quantity of potential sidelink positioning reference signal resources, and wherein the explicit identifier consists of a first quantity of bits that is equal to log₂(the first quantity of potential sidelink positioning reference signal resources) rounded up to a next highest integer. For example, the bit string 1450 may include just enough bits to uniquely specify (e.g., by indicating an index number of) any member of a subset of PRS resources, e.g., that is implicitly identified.

Also or alternatively, implementations of the method 1900 may include one or more of the following features. In an example implementation, the plurality of potential sidelink positioning reference signal resources of the second slot consists of a second quantity of potential sidelink positioning reference signal resources, wherein the reservation indication includes an explicit identifier that explicitly uniquely identifies the particular sidelink positioning reference signal resource of the second slot from among the plurality of potential sidelink positioning reference signal resources of the second slot, and wherein the explicit identifier consists of a second quantity of bits that is equal to log₂(the second quantity of potential sidelink positioning reference signal resources) rounded up to a next highest integer. For example, the PRS resource to be reserved may be explicitly identified using a bit string, e.g., the bit string 1350, with just enough bits to uniquely specify (e.g., by indicating an index number of) any member of the available PRS resources, e.g., the available PRS resources 1330₀-1330₁₉. In the example of FIG. 13, the minimum quantity (and thus preferably the actual quantity) of bits in a bit string to uniquely specify one of the 20 available PRS resources 1330₀-1330₁₉ is five bits. Thus, the bit string will have exactly five bits in order to uniquely specify a PRS resource from available PRS resources without transmitting any unnecessary bit, and thus conserving SL transmission overhead and processing power. In another example implementation, the particular sidelink positioning reference signal resource of the second slot is a second sidelink positioning reference signal resource, and wherein the control information includes a first-slot resource indication uniquely identifying, explicitly, implicitly, or a combination thereof, a first sidelink positioning reference signal resource of the first slot. For example, the control information of a slot of an SL message, such as the slot 1310 or the slot 1410, may include an indication of a PRS resource in the same slot as the control information, and the indication may be explicit (e.g., like the bit string 1350), implicit (e.g., if only the a future-slot PRS resource is explicitly or explicitly/implicitly indicated (i.e., a reverse of the situation described with respect to FIG. 17), or a combination thereof (e.g., such as the PRS resource indication 1610). In a further example implementation, the reservation indication is an implicit indication comprising the first-slot resource indication and an explicit indication of the second slot. For example, the indication of a reserved PRS resource may be completely implicit, for example, being implicitly the same as the same-slot PRS resource indication (e.g., a PRS resource indication 1710), e.g., due to absence of transmission of an explicit indication of a PRS resource for the future slot(s), and for the one or more indicated future slots, e.g., indicated by the future slot(s) indication 1720.

Also or alternatively, implementations of the method 1900 may include one or more of the following features. In an example implementation, the control information indicates at least a third slot, to be transmitted after the first slot, to reserve the particular sidelink positioning reference signal resource for the third slot. For example, a PRS resource may be reserved for multiple future slots by control information in a single slot, e.g., as shown and discussed with respect to FIG. 16 or FIG. 17. In another example implementation, the method 1900 further comprises determining whether to have the reservation indication uniquely identify the particular sidelink positioning reference signal resource of the second slot explicitly, implicitly, or with a combination thereof, based on at least one higher-layer communication received by the one or more receivers. For example, the UE 500 (e.g., the PRS resource reservation unit 550) may receive one or more instructions, e.g., the sidelink configuration message 1811, from the network entity 600 (e.g., the PRS unit 650) via one or more receivers of the transceiver 520. The UE 500 may determine how control information will identify a PRS resource to be reserved (and/or a PRS resource of a present slot to be indicated). The processor 510, possibly in combination with the memory 530, in combination with the transceiver 520 (e.g., the one or more receivers 524), may comprise means for determining whether to have the reservation indication uniquely identify the particular sidelink positioning reference signal resource of the second slot explicitly, implicitly, or with a combination thereof. In a further example implementation, the method 1900 may further comprise determining whether to have an explicit indication indicate which PRS resource of all of the plurality of potential sidelink positioning reference signal resources to reserve or which PRS resource of a subset of the plurality of potential sidelink positioning reference signal resources to reserve. For example, the PRS resource reservation unit 500 may, e.g., based on the message 1811, determine whether to use a bit string that can uniquely identify any available PRS resource to identify the PRS resource to reserve in a future slot or to use a bit string that can uniquely identify any available PRS resource of a subset of PRS resources, but not any available PRS resource, to identify the PRS resource to reserve in a future slot.

### Implementation Examples

Implementation examples are provided in the following numbered clauses.
Clause 1. A user equipment comprising:
   one or more memories;
   one or more transmitters; and
   one or more processors, communicatively coupled to the one or more memories and the one or more transmitters, configured to transmit, via the one or more transmitters, a wireless sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.
Clause 2. The user equipment of clause 1, wherein the one or more processors are configured to transmit the reservation indication, as one or more subcarriers or a combination of one or more symbols and one or more subcarriers, implicitly corresponding to a subset of the plurality of potential sidelink positioning reference signal resources configured in the dedicated SL PRS resource pool associated with the second slot, that contains less than all of the plurality of potential sidelink positioning reference signal resources configured in the dedicated SL PRS resource pool associated with the second slot, and wherein the reservation indication includes an explicit identifier that explicitly uniquely identifies the particular sidelink positioning reference signal resource of the second slot from among the subset of the plurality of potential sidelink positioning reference signal resources configured in the dedicated SL PRS resource pool associated with the second slot.
Clause 3. The user equipment of clause 2, wherein the subset of the plurality of potential sidelink positioning reference signal resources of the second slot consists of a first quantity of potential sidelink positioning reference signal resources, and wherein the explicit identifier consists of a first quantity of bits that is equal to log2(the first quantity of potential sidelink positioning reference signal resources) rounded up to a next highest integer.
Clause 4. The user equipment of clause 1, wherein the plurality of potential sidelink positioning reference signal resources of the second slot consists of a second quantity of potential sidelink positioning reference signal resources, wherein the reservation indication includes an explicit identifier that explicitly uniquely identifies the particular sidelink positioning reference signal resource of the second slot from among the plurality of potential sidelink positioning reference signal resources of the second slot, and wherein the explicit identifier consists of a second quantity of bits that is equal to log2(the second quantity of potential sidelink positioning reference signal resources) rounded up to a next highest integer.
Clause 5. The user equipment of clause 1, wherein the particular sidelink positioning reference signal resource of the second slot is a second sidelink positioning reference signal resource, and wherein the one or more processors are configured to have the control information include a first-slot resource indication uniquely identifying, explicitly, implicitly, or a combination thereof, a first sidelink positioning reference signal resource of the first slot.
Clause 6. The user equipment of clause 5, wherein the reservation indication is an implicit indication comprising the first-slot resource indication and an explicit indication of the second slot.
Clause 7. The user equipment of clause 1, wherein the one or more processors are configured to have the control information indicate at least a third slot, to be transmitted after the first slot, to reserve the particular sidelink positioning reference signal resource for the third slot.
Clause 8. The user equipment of clause 1, wherein the user equipment further comprises one or more receivers communicatively coupled to the one or more processors, and wherein the one or more processors are configured to determine whether to have the reservation indication uniquely identify the particular sidelink positioning reference signal resource of the second slot explicitly, implicitly, or with a combination thereof, based on at least one higher-layer communication received by the one or more receivers.
Clause 9. The user equipment of clause 8, wherein the one or more processors are configured to determine whether to have an explicit indication indicate which PRS resource of all of the plurality of potential sidelink positioning reference signal resources to reserve or which PRS resource of a subset of the plurality of potential sidelink positioning reference signal resources to reserve.
Clause 10. A method of reserving a sidelink positioning reference signal resource, the method comprising transmitting, from a user equipment, a wireless sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.
Clause 11. The method of clause 10, wherein transmitting the wireless sidelink message comprises transmitting the reservation indication, as one or more subcarriers or a combination of one or more symbols and one or more subcarriers, implicitly corresponding to a subset of the plurality of potential sidelink positioning reference signal resources configured in the dedicated SL PRS resource pool associated with the second slot, that contains less than all of the plurality of potential sidelink positioning reference signal resources configured in the dedicated SL PRS resource pool associated with the second slot, and wherein the reservation indication includes an explicit identifier that explicitly uniquely identifies the particular sidelink positioning reference signal resource of the second slot from among the subset of the plurality of potential sidelink positioning reference signal resources configured in the dedicated SL PRS resource pool associated with the second slot.
Clause 12. The method of clause 11, wherein the subset of the plurality of potential sidelink positioning reference signal resources of the second slot consists of a first quantity of potential sidelink positioning reference signal resources, and wherein the explicit identifier consists of a first quantity of bits that is equal to log2(the first quantity of potential sidelink positioning reference signal resources) rounded up to a next highest integer.
Clause 13. The method of clause 10, wherein the plurality of potential sidelink positioning reference signal resources of the second slot consists of a second quantity of potential sidelink positioning reference signal resources, wherein the reservation indication includes an explicit identifier that explicitly uniquely identifies the particular sidelink positioning reference signal resource of the second slot from among the plurality of potential sidelink positioning reference signal resources of the second slot, and wherein the explicit identifier consists of a second quantity of bits that is equal to log2(the second quantity of potential sidelink positioning reference signal resources) rounded up to a next highest integer.
Clause 14. The method of clause 10, wherein the particular sidelink positioning reference signal resource of the second slot is a second sidelink positioning reference signal resource, and wherein the control information includes a first-slot resource indication uniquely identifying, explicitly, implicitly, or a combination thereof, a first sidelink positioning reference signal resource of the first slot.
Clause 15. The method of clause 14, wherein the reservation indication is an implicit indication comprising the first-slot resource indication and an explicit indication of the second slot.
Clause 16. The method of clause 10, wherein the control information indicates at least a third slot, to be transmitted after the first slot, to reserve the particular sidelink positioning reference signal resource for the third slot.
Clause 17. The method of clause 10, further comprising determining whether to have the reservation indication uniquely identify the particular sidelink positioning reference signal resource of the second slot explicitly, implicitly, or with a combination thereof, based on at least one higher-layer communication received by the one or more receivers.
Clause 18. The method of clause 17, further comprising determining whether to have an explicit indication indicate which PRS resource of all of the plurality of potential sidelink positioning reference signal resources to reserve or which PRS resource of a subset of the plurality of potential sidelink positioning reference signal resources to reserve.
Clause 19. A user equipment comprising:
   means for determining a sidelink message; and
   means for transmitting the sidelink message wirelessly, the sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.
Clause 20. The user equipment of clause 19, wherein the means for transmitting the sidelink message comprise means for transmitting the reservation indication, as one or more subcarriers or a combination of one or more symbols and one or more subcarriers, implicitly corresponding to a subset of the plurality of potential sidelink positioning reference signal resources configured in the dedicated SL PRS resource pool associated with the second slot, that contains less than all of the plurality of potential sidelink positioning reference signal resources configured in the dedicated SL PRS resource pool associated with the second slot, and wherein the reservation indication includes an explicit identifier that explicitly uniquely identifies the particular sidelink positioning reference signal resource of the second slot from among the subset of the plurality of potential sidelink positioning reference signal resources configured in the dedicated SL PRS resource pool associated with the second slot.
Clause 21. The user equipment of clause 20, wherein the subset of the plurality of potential sidelink positioning reference signal resources of the second slot consists of a first quantity of potential sidelink positioning reference signal resources, and wherein the explicit identifier consists of a first quantity of bits that is equal to log2(the first quantity of potential sidelink positioning reference signal resources) rounded up to a next highest integer.
Clause 22. The user equipment of clause 19, wherein the plurality of potential sidelink positioning reference signal resources of the second slot consists of a second quantity of potential sidelink positioning reference signal resources, wherein the reservation indication includes an explicit identifier that explicitly uniquely identifies the particular sidelink positioning reference signal resource of the second slot from among the plurality of potential sidelink positioning reference signal resources of the second slot, and wherein the explicit identifier consists of a second quantity of bits that is equal to log2(the second quantity of potential sidelink positioning reference signal resources) rounded up to a next highest integer.
Clause 23. The user equipment of clause 19, wherein the particular sidelink positioning reference signal resource of the second slot is a second sidelink positioning reference signal resource, and wherein the control information includes a first-slot resource indication uniquely identifying, explicitly, implicitly, or a combination thereof, a first sidelink positioning reference signal resource of the first slot.
Clause 24. The user equipment of clause 23, wherein the reservation indication is an implicit indication comprising the first-slot resource indication and an explicit indication of the second slot.
Clause 25. The user equipment of clause 19, wherein the control information indicates at least a third slot, to be transmitted after the first slot, to reserve the particular sidelink positioning reference signal resource for the third slot.
Clause 26. The user equipment of clause 19, further comprising:
   means for receiving wireless signals; and
   means for determining whether to have the reservation indication uniquely identify the particular sidelink positioning reference signal resource of the second slot explicitly, implicitly, or with a combination thereof, based on at least one higher-layer communication received by the means for receiving wireless signals.
Clause 27. The user equipment of clause 26, wherein the means for determining whether to have the reservation indication uniquely identify the particular sidelink positioning reference signal resource of the second slot explicitly, implicitly, or with a combination thereof comprise means for determining whether to have an explicit indication indicate which PRS resource of all of the plurality of potential sidelink positioning reference signal resources to reserve or which PRS resource of a subset of the plurality of potential sidelink positioning reference signal resources to reserve.
Clause 28. A non-transitory, processor-readable storage medium comprising processor-readable instructions to cause one or more processors of a user equipment to transmit a sidelink message wirelessly via one or more transmitters of the user equipment, the sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.
Clause 29. The non-transitory, processor-readable storage medium of clause 28, wherein the processor-readable instructions to cause the one or more processors to transmit the sidelink message comprise processor-readable instructions to cause the one or more processors to transmit the reservation indication, as one or more subcarriers or a combination of one or more symbols and one or more subcarriers, implicitly corresponding to a subset of the plurality of potential sidelink positioning reference signal resources configured in the dedicated SL PRS resource pool associated with the second slot, that contains less than all of the plurality of potential sidelink positioning reference signal resources configured in the dedicated SL PRS resource pool associated with the second slot, and wherein the reservation indication includes an explicit identifier that explicitly uniquely identifies the particular sidelink positioning reference signal resource of the second slot from among the subset of the plurality of potential sidelink positioning reference signal resources configured in the dedicated SL PRS resource pool associated with the second slot.
Clause 30. The non-transitory, processor-readable storage medium of clause 29, wherein the subset of the plurality of potential sidelink positioning reference signal resources of the second slot consists of a first quantity of potential sidelink positioning reference signal resources, and wherein the explicit identifier consists of a first quantity of bits that is equal to log2(the first quantity of potential sidelink positioning reference signal resources) rounded up to a next highest integer.
Clause 31. The non-transitory, processor-readable storage medium of clause 28, wherein the plurality of potential sidelink positioning reference signal resources of the second slot consists of a second quantity of potential sidelink positioning reference signal resources, wherein the reservation indication includes an explicit identifier that explicitly uniquely identifies the particular sidelink positioning reference signal resource of the second slot from among the plurality of potential sidelink positioning reference signal resources of the second slot, and wherein the explicit identifier consists of a second quantity of bits that is equal to log2(the second quantity of potential sidelink positioning reference signal resources) rounded up to a next highest integer.
Clause 32. The non-transitory, processor-readable storage medium of clause 28, wherein the particular sidelink positioning reference signal resource of the second slot is a second sidelink positioning reference signal resource, and wherein the control information includes a first-slot resource indication uniquely identifying, explicitly, implicitly, or a combination thereof, a first sidelink positioning reference signal resource of the first slot.
Clause 33. The non-transitory, processor-readable storage medium of clause 32, wherein the reservation indication is an implicit indication comprising the first-slot resource indication and an explicit indication of the second slot.
Clause 34. The non-transitory, processor-readable storage medium of clause 28, wherein the control information indicates at least a third slot, to be transmitted after the first slot, to reserve the particular sidelink positioning reference signal resource for the third slot.
Clause 35. The non-transitory, processor-readable storage medium of clause 28, further comprising processor-readable instructions to cause the one or more processors to determine whether to have the reservation indication uniquely identify the particular sidelink positioning reference signal resource of the second slot explicitly, implicitly, or with a combination thereof, based on at least one higher-layer communication received by the user equipment.
Clause 36. The non-transitory, processor-readable storage medium of clause 35, wherein the processor-readable instructions to cause the one or more processors to determine whether to have the reservation indication uniquely identify the particular sidelink positioning reference signal resource of the second slot explicitly, implicitly, or with a combination thereof comprise processor-readable instructions to cause the one or more processors to determine whether to have an explicit indication indicate which PRS resource of all of the plurality of potential sidelink positioning reference signal resources to reserve or which PRS resource of a subset of the plurality of potential sidelink positioning reference signal resources to reserve.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment comprising:
one or more memories;
one or more transmitters; and
one or more processors, communicatively coupled to the one or more memories and the one or more transmitters, configured to transmit, via the one or more transmitters, a wireless sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.

2. The user equipment of claim 1, wherein the one or more processors are configured to transmit the reservation indication, as one or more subcarriers or a combination of one or more symbols and one or more subcarriers, implicitly corresponding to a subset of the plurality of potential sidelink positioning reference signal resources configured in the dedicated SL PRS resource pool associated with the second slot, that contains less than all of the plurality of potential sidelink positioning reference signal resources configured in the dedicated SL PRS resource pool associated with the second slot, and wherein the reservation indication includes an explicit identifier that explicitly uniquely identifies the particular sidelink positioning reference signal resource of the second slot from among the subset of the plurality of potential sidelink positioning reference signal resources configured in the dedicated SL PRS resource pool associated with the second slot.

3. The user equipment of claim 2, wherein the subset of the plurality of potential sidelink positioning reference signal resources of the second slot consists of a first quantity of potential sidelink positioning reference signal resources, and wherein the explicit identifier consists of a first quantity of bits that is equal to log₂(the first quantity of potential sidelink positioning reference signal resources) rounded up to a next highest integer.

4. The user equipment of claim 1, wherein the plurality of potential sidelink positioning reference signal resources of the second slot consists of a second quantity of potential sidelink positioning reference signal resources, wherein the reservation indication includes an explicit identifier that explicitly uniquely identifies the particular sidelink positioning reference signal resource of the second slot from among the plurality of potential sidelink positioning reference signal resources of the second slot, and wherein the explicit identifier consists of a second quantity of bits that is equal to log₂(the second quantity of potential sidelink positioning reference signal resources) rounded up to a next highest integer.

5. The user equipment of claim 1, wherein the particular sidelink positioning reference signal resource of the second slot is a second sidelink positioning reference signal resource, and wherein the one or more processors are configured to have the control information include a first-slot resource indication uniquely identifying, explicitly, implicitly, or a combination thereof, a first sidelink positioning reference signal resource of the first slot.

6. The user equipment of claim 5, wherein the reservation indication is an implicit indication comprising the first-slot resource indication and an explicit indication of the second slot.

7. The user equipment of claim 1, wherein the one or more processors are configured to have the control information indicate at least a third slot, to be transmitted after the first slot, to reserve the particular sidelink positioning reference signal resource for the third slot.

8. The user equipment of claim 1, wherein the user equipment further comprises one or more receivers communicatively coupled to the one or more processors, and wherein the one or more processors are configured to determine whether to have the reservation indication uniquely identify the particular sidelink positioning reference signal resource of the second slot explicitly, implicitly, or with a combination thereof, based on at least one higher-layer communication received by the one or more receivers.

9. The user equipment of claim 8, wherein the one or more processors are configured to determine whether to have an explicit indication indicate which PRS resource of all of the plurality of potential sidelink positioning reference signal resources to reserve or which PRS resource of a subset of the plurality of potential sidelink positioning reference signal resources to reserve.

10. A method of reserving a sidelink positioning reference signal resource, the method comprising transmitting, from a user equipment, a wireless sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.

11. The method of claim 10, wherein transmitting the wireless sidelink message comprises transmitting the reservation indication, as one or more subcarriers or a combination of one or more symbols and one or more subcarriers, implicitly corresponding to a subset of the plurality of potential sidelink positioning reference signal resources configured in the dedicated SL PRS resource pool associated with the second slot, that contains less than all of the plurality of potential sidelink positioning reference signal resources configured in the dedicated SL PRS resource pool associated with the second slot, and wherein the reservation indication includes an explicit identifier that explicitly uniquely identifies the particular sidelink positioning reference signal resource of the second slot from among the subset of the plurality of potential sidelink positioning reference signal resources configured in the dedicated SL PRS resource pool associated with the second slot.

12. The method of claim 11, wherein the subset of the plurality of potential sidelink positioning reference signal resources of the second slot consists of a first quantity of potential sidelink positioning reference signal resources, and wherein the explicit identifier consists of a first quantity of bits that is equal to log₂(the first quantity of potential sidelink positioning reference signal resources) rounded up to a next highest integer.

13. The method of claim 10, wherein the plurality of potential sidelink positioning reference signal resources of the second slot consists of a second quantity of potential sidelink positioning reference signal resources, wherein the reservation indication includes an explicit identifier that explicitly uniquely identifies the particular sidelink positioning reference signal resource of the second slot from among the plurality of potential sidelink positioning reference signal resources of the second slot, and wherein the explicit identifier consists of a second quantity of bits that is equal to log₂(the second quantity of potential sidelink positioning reference signal resources) rounded up to a next highest integer.

14. The method of claim 10, wherein the particular sidelink positioning reference signal resource of the second slot is a second sidelink positioning reference signal resource, and wherein the control information includes a first-slot resource indication uniquely identifying, explicitly, implicitly, or a combination thereof, a first sidelink positioning reference signal resource of the first slot.

15. The method of claim 14, wherein the reservation indication is an implicit indication comprising the first-slot resource indication and an explicit indication of the second slot.

16. The method of claim 10, wherein the control information indicates at least a third slot, to be transmitted after the first slot, to reserve the particular sidelink positioning reference signal resource for the third slot.

17. The method of claim 10, further comprising determining whether to have the reservation indication uniquely identify the particular sidelink positioning reference signal resource of the second slot explicitly, implicitly, or with a combination thereof, based on at least one higher-layer communication received by the one or more receivers.

18. The method of claim 17, further comprising determining whether to have an explicit indication indicate which PRS resource of all of the plurality of potential sidelink positioning reference signal resources to reserve or which PRS resource of a subset of the plurality of potential sidelink positioning reference signal resources to reserve.

19. A user equipment comprising:
means for transmitting a sidelink message wirelessly, the sidelink message including a first slot of information comprising control information that indicates a second slot, to be transmitted after the first slot, and that includes a reservation indication of a particular sidelink positioning reference signal (SL PRS) resource of the second slot from among a plurality of potential sidelink positioning reference signal resources configured in a dedicated SL PRS resource pool associated with the second slot, the reservation indication uniquely identifying, explicitly, implicitly, or a combination thereof, the particular sidelink positioning reference signal resource of the second slot from among the plurality of potential sidelink positioning reference signal resources of the second slot.

20. The user equipment of claim 19, wherein the means for transmitting the sidelink message comprise means for transmitting the reservation indication, as one or more subcarriers or a combination of one or more symbols and one or more subcarriers, implicitly corresponding to a subset of the plurality of potential sidelink positioning reference signal resources configured in the dedicated SL PRS resource pool associated with the second slot, that contains less than all of the plurality of potential sidelink positioning reference signal resources configured in the dedicated SL PRS resource pool associated with the second slot, and wherein the reservation indication includes an explicit identifier that explicitly uniquely identifies the particular sidelink positioning reference signal resource of the second slot from among the subset of the plurality of potential sidelink positioning reference signal resources configured in the dedicated SL PRS resource pool associated with the second slot.
